(19) United States
(12) Patent Application Publication
(10) Pub. No.: US 2022/0149494 A1
(43) Pub. Date: May 12, 2022

(54) ELECTRODE FOR SOLID-STATE BATTERY

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/453,645

(22) Filed: Nov. 4, 2021

(30) Foreign Application Priority Data
Nov. 12, 2020 (JP) 2020-188540

(51) Int. Cl. H01M 50/583; H01M 4/80; H01M 4/66; H01M 50/581

(52) U.S. Cl. CPC H01M 50/583; H01M 4/80; H01M 2200/103; H01M 50/581; H01M 4/661

(57) ABSTRACT

To provide a solid-state battery having high safety and high energy density. An electrode for a solid-state battery includes a current collector that is a metal porous body, and an electrode material mixture with which the current collector is filled. The current collector has an end portion having a material mixture non-filled region that is not filled with the electrode material mixture. The material mixture non-filled region has a part that is a fuse function portion. The fuse function portion has a smaller total cross-sectional area of metal in a cross section perpendicular to a direction of the end portion than the rest of the material mixture non-filled region.

This application is based on and claims the benefit of priority from Japanese Patent Application No. 2020-188540, filed on 12 Nov. 2020, the content of which is incorporated herein by reference.

### BACKGROUND OF THE INVENTION

### Field of the Invention

The present invention relates to an electrode for a solid-state battery.

### Related Art

Recently, the demand for batteries with high capacity and high output has rapidly expanded due to the spread of various electric and electronic devices of various sizes such as automobiles, personal computers, and mobile phones. As such a battery, a liquid battery cell in which an organic electrolytic solution is used as an electrolyte between a positive electrode and a negative electrode is widely used.

The battery is used in connection with a fuse to prevent damage to components or accidents when overcurrent flows during abnormal conditions. For example, a secondary battery mounted for driving an electric vehicle is used in connection with a fuse that interrupts current by blowing due to an overcurrent (for example, see Patent Document 1).

Patent Document 1: Japanese Unexamined Patent Application, Publication No. 2014-150664

### SUMMARY OF THE INVENTION

As the electrolyte of the liquid battery cell, a combustible electrolytic solution is widely used. If a fuse is installed inside the battery, a spark generated when the fuse blows may cause the electrolytic solution to ignite and burn. Accordingly, as disclosed in Patent Document 1, a battery including a combustible electrolytic solution is used by being connected to a fuse external to the battery. However, it is preferable that the fuse is provided in a location close to a location where a chemical reaction occurs, from the viewpoint of faster detection of abnormalities and reduction of accident risks.

Incidentally, in recent years, techniques relating to a solid-state battery using a flame-retardant solid electrolyte as an electrolyte have been proposed. Among them, it has been proposed to use a porous metal as current collectors constituting a positive electrode layer and a negative electrode layer as a method of increasing the filling density of an electrode active material. In a solid-state battery, even if a fuse is provided in the battery cell, there is no risk of ignition accidents unlike a liquid battery cell. However, a preferred fuse structure for solid-state batteries has not been studied.

In response to the above issue, it is an object of the present invention to provide a solid-state battery having higher safety and higher energy density.

(1) A first aspect of the present invention relates to an electrode for a solid-state battery. The electrode includes a current collector that is a metal porous body, and an electrode material mixture with which the current collector is filled. The current collector has an end portion having a material mixture non-filled region that is not filled with the electrode material mixture. The material mixture non-filled region has a part that is a fuse function portion. The fuse function portion has a smaller total cross-sectional area of metal in a cross section perpendicular to a direction of the end portion than the rest of the material mixture non-filled region.

According to the invention of the first aspect, it is possible to provide a solid-state battery having higher safety and higher energy density.

(2) In a second aspect of the present invention according to the first aspect, the fuse function portion has a higher porosity and/or a smaller metal wire diameter than the rest of the material mixture non-filled region.

According to the Invention of the second aspect, it is possible to form a fuse function portion having a fuse function by adjusting the porosity in a material mixture non-filled region.

(3) In a third aspect of the present invention according to the first or second aspect, at least a part of the fuse function portion is filled with at least one of an insulating material, a reinforcing material, and a heat insulating material.

According to the invention of the third aspect, it is possible to improve the strength of a fuse function portion and to provide a solid-state battery with higher safety.

### BRIEF DESCRIPTION OF THE DRAWINGS

FIG. 1 is a diagram showing a solid-state battery according to an embodiment of the present invention;

FIG. 2 is a side cross-sectional view showing an electrode for the solid-state battery according to the embodiment of the present invention;

FIG. 3 is a top cross-sectional view showing the electrode for the solid-state battery according to the embodiment of the present invention;

FIG. 4 is a top view showing an electrode for a solid-state battery according to another embodiment of the present invention; and

FIG. 5 is a cross-sectional view taken along line A-A in FIG. 4.

### DETAILED DESCRIPTION OF THE INVENTION

Embodiments of the present invention will now be described with reference to the drawings. In this regard, however, the following embodiments exemplify the present invention, and the present invention is not limited to the following embodiments.

### First Embodiment

### Solid-State Battery

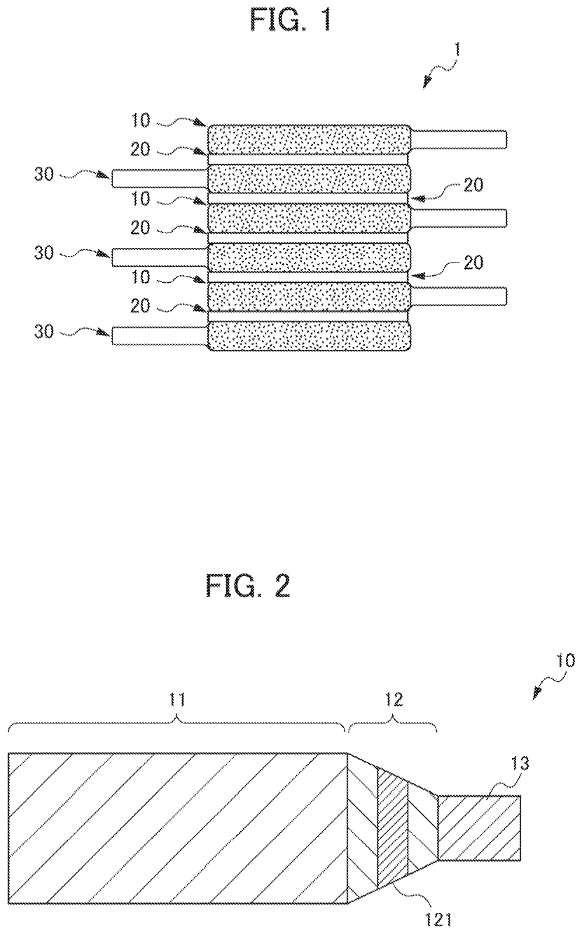

As shown in FIG. 1, a solid-state battery 1 according to the present embodiment includes a laminate of a positive electrode 10, a negative electrode 30, and a solid electrolyte 20 disposed between the positive electrode 10 and the negative electrode 30. The solid-state battery 1 is obtained by sandwiching and pressing the laminate from the outside of the positive electrode 10 and the negative electrode 30.

### Positive Electrode and Negative Electrode

The positive electrode 10 and the negative electrode 30, which are electrodes for the solid-state battery according to the present embodiment, each include a current collector that is a metal porous body, and an electrode material mixture with which the current collector is filled. In the following description, the positive electrode 10 will be described as an example, and the same structure can apply to the negative electrode 30.

### Current Collector

The current collectors constituting the positive electrode 10 and the negative electrode 30 are each made of a metal porous body. The metal porous body has pores that are continuous with each other, and the pore can be filled with an electrode material mixture including an electrode active material. The form of the metal porous body is not limited as long as it has pores that are continuous with each other. Examples of the form of the metal porous body include a foam metal having pores by foaming, a metal mesh, an expanded metal, a punching metal, and a metal nonwoven fabric. The metal used in the metal porous body is not limited as long as it has electric conductivity. Examples thereof include nickel, aluminum, stainless steel, titanium, copper, and silver. Among these, as the current collector constituting the positive electrode, a foamed aluminum, foamed nickel, and foamed stainless steel are preferable. As the current collector constituting the negative electrode, a foamed copper and foamed stainless steel are preferable.

The current collector, which is a metal porous body, has pores that are continuous with each other inside, and has a surface area larger than that of a conventional current collector that is metal foil. By using the above-described metal porous body as a current collector, the pore can be filled with an electrode material mixture including an electrode active material. This allows the amount of active material per unit area of the electrode layer to be increased, and as a result, the volumetric energy density of the solid-state battery can be improved. In addition, since the electrode material mixture is easily fixed, it is not necessary to thicken a coating slurry for forming the electrode material mixture layer when a film of the electrode material mixture layer is thickened, unlike a conventional electrode using a metal foil as a current collector. Therefore, it is possible to reduce a binder such as an organic polymer compound that has been necessary for thickening. Accordingly, the capacity per unit area of the electrode can be increased, and a higher capacity of the solid-state battery can be achieved.

The structure of the current collector will be described taking the positive electrode 10 as an example, and the same structure can apply to the negative electrode 30. FIG. 2 is a side cross-sectional view showing an aspect of the positive electrode 10 according to the present embodiment. As shown in FIG. 2, the positive electrode 10 includes a material mixture filled region 11 that is filled with the positive electrode material mixture, a material mixture non-filled region 12, and a current collecting tab forming portion 13. The material mixture non-filled region 12 and the current collecting tab forming portion 13 are not filled with the positive electrode material mixture. The density of the current collecting tab forming portion 13 is higher than the density of the material mixture non-filled region 12. The above-described structure is produced because, after the material mixture filled region 11 is filled with the positive electrode material mixture, the current collecting tab forming portion 13, which is further from the material mixture filled region 12 than the material mixture non-filled region 12, is easily extended during rolling for the purpose of improving the filling density of the electrode active material of the positive electrode 10 and thinning the layer. The current collecting tab forming portion 13 is electrically connected to a lead tab (not shown) by welding or the like.

### Electrode Material Mixture

The electrode material mixture with which the material mixture filled region 11 of the current collector is filled, includes at least an electrode active material. The electrode material mixture applicable to this embodiment may optionally include other components as long as it includes an electrode active material as an essential component. The other components are not limited, and may be any components that can be used in making a solid-state battery. Examples thereof include a solid electrolyte, a conductivity aid, and a binder.

The positive electrode material mixture constituting the positive electrode 10 contains at least a positive electrode active material, and may contain other components such as a solid electrolyte, a conductivity aid, and a binder. The positive electrode active material is not limited as long as it can occlude and release lithium ions. Examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, Li(Ni_{1/3}Co_{1/3}Mn_{1/3})O₂, LiCoO₄, LiMn₂O₄, LiNiO₂, LiFePO₄, lithium sulfide, and sulfur.

The negative electrode material mixture constituting the negative electrode 30 contains at least a negative electrode active material, and may contain other components such as a solid electrolyte, a conductivity aid, and a binder. The negative electrode active material is not limited as long as it can occlude and release lithium ions. Examples thereof include metallic lithium, lithium alloys, metal oxides, metal sulfides, metal nitrides, Si, SiO, and carbon materials such as artificial graphite, natural graphite, hard carbon, and soft carbon.

### Solid Electrolyte

The solid electrolyte 20 is laminated between the positive electrode 10 and the negative electrode 30, and is formed in the form of a layer, for example. The solid electrolyte 20 is a layer containing at least a solid electrolyte material. Charge transfer between the positive electrode active material and the negative electrode active material can be performed via the solid electrolyte material.

The solid electrolyte material is not limited, and examples thereof include a sulfide solid electrolyte material, an oxide solid electrolyte material, a nitride solid electrolyte material, and a halide solid electrolyte material.

In addition to the above, the solid-state battery 1 includes a lead terminal and an exterior packaging body. First ends of the lead terminals are electrically connected by welding or the like to current collecting tab forming portions of the positive electrode 10 and the negative electrode 30, respectively, and other ends thereof extend from the exterior packaging body to respectively constitute electrode portions of the solid-state battery. The lead terminal is not limited, and for example, a flexible linear plate-like member such as aluminum or copper is used. The exterior packaging body houses the laminate including the positive electrode 10, the solid electrolyte 20, and the negative electrode 30, and a part of the lead terminals. The exterior packaging body is not limited, and for example, a laminate cell made of a laminate film is used.

### Material Mixture Non-Filled Region

The material mixture non-filled region 12 is formed by not filling a part of the current collector with the electrode material mixture. The material mixture non-filled region 12 includes a fuse function portion having a fuse function.

### Fuse Function Portion

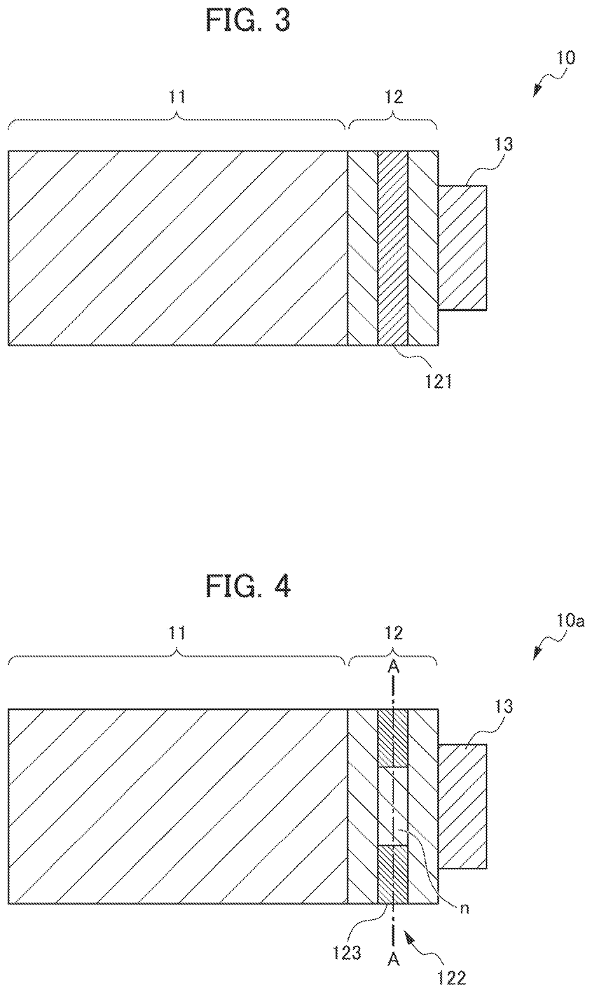

The fuse function portion is formed in a part of the material mixture non-filled region 12 as a portion where the total cross-sectional area of a metal portion constituting the metal porous body is smaller than that of the rest of the material mixture non-filled region 12. The cross section is perpendicular to the direction of an end portion. The direction of the end portion is the extending direction of the current collecting tab forming portion 13, which is the direction in which electrons flow. In the present embodiment, the material mixture non-filled region 12 includes a fuse function portion 121. FIG. 3 is a top cross-sectional view showing an aspect of the positive electrode 10 according to the present embodiment. As shown in FIGS. 2 and 3, the fuse function portion 121 is formed, for example, in the form of a layer perpendicular to the extending direction of the current collecting tab forming portion 13, which is the direction in which electrons flow.

In the fuse function portion 121, a rated current is set. When an overcurrent (fusing current) exceeding the rated current flows through the fuse function portion 121, the fuse function portion 121 blows due to heat. Thus, an abnormality occurs. When an overcurrent flows to the fuse function portion 121, the fuse function portion 121 blows, and the solid-state battery 1 and an external device are protected. The overcurrent may be any of an external short-circuit current flowing from the outside of the solid-state battery 1 to the solid-state battery 1, or an internal short-circuit current flowing from the inside of the solid-state battery 1 to the outside.

In the present embodiment, the fuse function portion 121 has a higher porosity and/or a smaller metal wire diameter than the rest of the mixture material non-filled region 12. Incidentally, the metal wire diameter means the diameter of the linear metal portion constituting the metal porous body. Thus, the fuse function portion 121 preferentially blows when the overcurrent occurs. Accordingly, it is possible to set the rated current, at which the fuse function portion 121 blows, in the fuse function portion 121 by adjusting the porosity and/or metal wire diameter.

The fuse function portion 121 is formed, for example, in the following manner: The material mixture filled region 11 of the current collector is filled with the positive electrode material mixture, and then the positive electrode 10 is rolled and the material mixture non-filled region 12 and the current collecting tab forming portion 13 are formed. Subsequently, a part of the material mixture non-filled region 12 is corroded with a chemical substance such as an acid or a halide, or subjected to laser processing, and thus the fuse function portion 121 is formed. Alternatively, when a metal porous body used as a current collector is produced, a portion having a higher porosity and/or a smaller metal wire diameter is provided in a part of the metal porous body, and the portion may be used as the fuse function portion 121.

It is preferable that at least a part of the pores of the fuse function portion 121 is filled with at least one of an insulating material, a reinforcing material, and a heat insulating material. This can improve the strength of the fuse function portion 121, which has a high porosity and low physical strength. This can prevent breakage of the fuse function portion 121 due to physical stress and a short circuit caused by the breakage. Further, this can prevent the positive electrode 10 from slipping in the cell when the fuse function portion 121 is fused, thus suppressing a short circuit caused by the slip.

The insulating material is not limited as long as it has an electrical insulating property and can be fixed in a state of filling a void of the fuse function portion 121. The reinforcing material is not limited as long as it satisfies the conditions for the insulating material and has a predetermined strength. The heat insulating material is not limited as long as it satisfies the conditions for the insulating material and has a thermal conductivity of a certain value or less. Examples of the insulating material, the reinforcing material, and the heat insulating material include metal oxides such as alumina, synthetic resins, and mixtures thereof.

The synthetic resin is not limited, and examples thereof include thermosetting resins such as a polyimide resin, an epoxy resin, a silicone resin, and a polyurethane resin; thermoplastic resins such as a polyolefin resin, a polystyrene resin, a fluorine resin, a polyvinyl chloride resin, a polymethacrylic acid resin, and a polyurethane resin; and photocurable resins such as a silicone resin, a polymethacrylic acid resin, and a polyester resin.

The fuse function portion 121 is formed by utilizing a part of the material mixture non-filled region 12. This allows the fuse function portion 121 to be disposed near the laminate where electrochemical reaction occurs, thereby shortening the time until the current is cut off in the event of an abnormality and reducing the risk of an accident. In addition to the above, by disposing the fuse function portion 121 inside the solid-state battery 1, it becomes unnecessary to dispose a fuse outside the solid-state battery 1, for example, on a bus bar. Accordingly, the installation space of the solid-state battery 1 can be reduced, and thus the volumetric energy density of the solid-state battery 1 can be improved.

In the present embodiment, a structure in which the fuse function portion 121 is provided in the positive electrode 10 has been described. It is preferable that a fuse function portion having the same structure is also provided in the negative electrode 30. Further, it is preferable that in the solid-state battery 1 in which a plurality of positive electrodes 10 and negative electrodes 30 are laminated, the plurality of positive electrodes 10 and negative electrodes 30 are each provided with a fuse function portion.

Another embodiment of the present invention is described below. Description of the same structure as that of the first embodiment may be omitted.

### Second Embodiment

FIG. 4 is a top view showing a positive electrode 10a according to a second embodiment. In the present embodiment, a material mixture non-filled region 12 includes a fuse function portion 122.

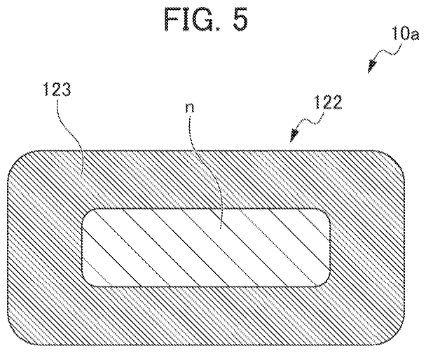

The fuse function portion 122 is formed, for example, to have a region n having a smaller cross-sectional area of a metal porous body than the rest of the material mixture non-filled region 12, in a cross section perpendicular to the extending direction of a current collecting tab forming portion 13, which is the direction in which electrons flow. FIG. 5 is a cross-sectional view taken along line A-A in FIG. 4. As shown in FIG. 5, the region n of the fuse function portion 122 has a smaller cross-sectional area of the metal porous body than the rest of the material mixture non-filled region 12.

With the above structure of the fuse function portion 122, similarly to the fuse function portion 121, the fuse function portion 122 preferentially blows when an overcurrent occurs. Accordingly, it is possible to set a rated current, at which the fuse function portion 122 blows, in the fuse function portion 122 by adjusting the above cross-sectional area of the fuse function portion 122.

It is preferable that at least a part of pores of the region n is filled with at least one of an insulating material, a reinforcing material, and a heat insulating material. Also, it is preferable that at least one of an insulating material, a reinforcing material, and a heat insulating material is similarly disposed in a region 123 around the region n. This can improve the strength of the fuse function portion 122, which has the region n having a smaller cross-sectional area of the metal porous body than the rest of the material mixture non-filled region 12. With respect to the insulating material, the reinforcing material, and the heat insulating material mentioned above, the same structure as in the first embodiment can be applied.

The fuse function portion 122 is formed, for example, in the following manner: The material mixture filled region 11 of the current collector is filled with the positive electrode material mixture, and then the positive electrode 10a is rolled and the material mixture non-filled region 12 and the current collecting tab forming portion 13 are formed. Subsequently, a part of the material mixture non-filled region 12 is removed, and thus the fuse function portion 122 is formed. Alternatively, when a metal porous body used as a current collector is produced, a portion having a smaller cross-sectional area is provided in a part of the metal porous body, and the portion may be used as the fuse function portion 122.

Preferred embodiments of the present invention have been described above. The present invention is not limited to the above embodiments, and can be modified as appropriate.

### EXPLANATION OF REFERENCE NUMERALS

1 solid-state battery

10, 10a positive electrode (electrode for solid-state battery)

12 material mixture non-filled region

121, 122 fuse function portion

What is claimed is:

1. An electrode for a solid-state battery, the electrode comprising:
a current collector that is a metal porous body; and
an electrode material mixture with which the current collector is filled,
the current collector having an end portion having a material mixture non-filled region that is not filled with the electrode material mixture,
the material mixture non-filled region having a part that is a fuse function portion, the fuse function portion having a smaller total cross-sectional area of metal in a cross section perpendicular to a direction of the end portion than the rest of the material mixture non-filled region.

2. The electrode for a solid-state battery according to claim 1, wherein the fuse function portion has a higher porosity and/or a smaller metal wire diameter than the rest of the material mixture non-filled region.

3. The electrode for a solid-state battery according to claim 1, wherein at least a part of the fuse function portion is filled with at least one of an insulating material, a reinforcing material, and a heat insulating material.
